(19) United States
(12) Patent Application Publication
(10) Pub. No.: US 2017/0012450 A1
(43) Pub. Date: Jan. 12, 2017

(54) COMPUTING DEVICE CHARGING CASES AND METHODS OF USE

(71) Applicant: William J. Warren, Frisco, TX (US)

(72) Inventor: William J. Warren, Frisco, TX (US)

(21) Appl. No.: 15/252,018

(22) Filed: Aug. 30, 2016

Related U.S. Application Data
(63) Continuation-in-part of application No. 15/139,215, filed on Apr. 26, 2016.
Application No. 15/139,215 is a continuation-in-part of application No. 15/008,402, filed on Jan. 27, 2016.
Application No. 15/008,402 is a continuation-in-part of application No. 14/634,568, filed on Feb. 27, 2015.
(60) Provisional application No. 62/231,762, filed on Jul. 14, 2015.
(60) Provisional application No. 61/998,497, filed on Jun. 29, 2014.
(60) Provisional application No. 61/998,646, filed on Jul. 2, 2014.
(60) Provisional application No. 61/998,649, filed on Jul. 3, 2014.
(60) Provisional application No. 61/998,770, filed on Jul. 6, 2014.
(60) Provisional application No. 62/124,684, filed on Dec. 29, 2014.
(60) Provisional application No. 62/179,669, filed on May 14, 2015.
(60) Provisional application No. 62/231,762, filed on Jul. 14, 2015.
(60) Provisional application No. 62/321,992, filed on Apr. 13, 2016.
(60) Provisional application No. 62/331,163, filed on May 3, 2016.
(60) Provisional application No. 62/333,019, filed on May 6, 2016.
(60) Provisional application No. 62/333,177, filed on May 7, 2016.
(60) Provisional application No. 62/335,288, filed on May 12, 2016.
(60) Provisional application No. 62/337,275, filed on May 16, 2016.

(51) Int. Cl. H02J 7/00; G06F 1/16

(52) U.S. Cl. CPC H02J 7/0042; H02J 7/0052; G06F 1/1633

(57) ABSTRACT

Electrical charging device chassis and cases are provided herein. An example device includes a charging case that protectingly surrounds or encases a computing device in such a way that a touchscreen display or keyboard is at least partially exposed to allow a user to utilize the same, a charging circuit disposed within the charging case, and a charging interface extending from the charging case.

### CROSS-REFERENCE TO RELATED APPLICATIONS

The present application is a Continuation-in-Part of U.S. patent application Ser. No. 15/139,215, filed on Apr. 26, 2016, which is a Continuation-in-Part of U.S. patent application Ser. No. 15/008,402, filed on Jan. 27, 2016, which is a Continuation-in-Part of U.S. patent application Ser. No. 14/634,568, filed on Feb. 27, 2015, which claims the benefit of U.S. Provisional Application No. 61/998,497, filed on Jun. 29, 2014, of U.S. Provisional Application No. 61/998,646, filed on Jul. 2, 2014, of U.S. Provisional Application No. 61/998,649, filed on Jul. 3, 2014, of U.S. Provisional Application No. 61/998,770, filed on Jul. 6, 2014, and of U.S. Provisional Application No. 62/124,684, filed on Dec. 29, 2014; the present application also claims the benefit of U.S. Provisional Application No. 62/321,992, filed on Apr. 13, 2016, of U.S. Provisional Application No. 62/331,163, filed on May 3, 2016, of U.S. Provisional Application No. 62/330,019, filed on May 6, 2016, of U.S. Provisional Application No. 62/333,177, filed on May 7, 2016, of U.S. Provisional Application No. 62/335,288, filed on May 12, 2016, and of U.S. Provisional Application No. 62/337,275, filed on May 16, 2016; U.S. patent application Ser. No. 15/008,402 also claims the benefit of U.S. Provisional Application No. 62/179,669, filed on May 14, 2015, and of U.S. Provisional Application No. 62/231,762, filed on Jul. 14, 2015. The present application is also related to U.S. patent application Ser. No. ______, filed on Aug. 30, 2016, entitled “Computing Device Charging Cases and Methods of Use.” All of the above applications are hereby incorporated by reference herein for all purposes including all references and appendices cited therein.

### FIELD OF TECHNOLOGY

The present technology pertains to charging cases for electronic devices such as Smartphones, and more specifically, but not by way of limitation, to charging cases that comprise a static or deployable DC or AC electrical connector (such as USB or electrical prongs) that extends from a compartment of the charging cases.

### SUMMARY

According to some embodiments, the present technology is directed to a device, comprising: (a) a charging case that protectingly surrounds or encases a computing device in such a way that a touchscreen display or keyboard is at least partially exposed to allow a user to utilize the touchscreen display or keyboard; (b) a charging circuit disposed within the charging case; and (c) a charging interface extending from the charging case

According to some embodiments, the present technology is directed to a device, comprising: (a) a charging case that protectingly surrounds a computing device in such a way that a touchscreen display or keyboard is at least partially exposed to allow a user to utilize the touchscreen display or keyboard; (b) a charging circuit disposed within a middle compartment of the charging case, the middle compartment being disposed behind the smartphone; (c) a charging interface selectively extendable from the charging case; and (d) an extendable stabilizer disposed within a rearward compartment behind the middle compartment, the extendable stabilizer translatable between a stored configuration and a deployed configuration.

According to some embodiments, the present technology is directed to a device, comprising: (a) a charging case that protectingly surrounds a smartphone or other computing device; (b) a first compartment coupled to a rearward portion of the charging case; (c) a charging circuit disposed within the first compartment; (d) a charging interface extendable from the charging case, the charging interface disposed within the first compartment; (e) a second compartment coupled to a rearward portion of the first compartment; and (f) a stabilizer device that is extendable from the second compartment.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a front perspective view of an example device of the present disclosure with components in a stored configuration.

FIG. 2 is a side perspective view of the example device of FIG. 1, with components in a deployed configuration.

FIG. 3 is a rear perspective view of the device of FIG. 1 in a deployed configuration illustrating sliding movement of a stabilizer and electrical interface.

FIG. 4 is a perspective view of another example embodiment of the present disclosure having a vertically oriented USB connector.

FIG. 5 is a perspective view of another example embodiment of the present disclosure having a horizontally oriented USB connector.

FIG. 6 is a perspective view of another example embodiment of the present disclosure having a pivoting stabilizer.

FIG. 7 is a rear perspective view of the device of FIG. 6.

FIG. 8 is a close up front perspective view of the FIG. 6 illustrating a stabilizer locking member.

FIG. 9 is a perspective view of another embodiment of the present disclosure.

FIG. 10 is a perspective view of a portion of another embodiment of the present disclosure having multiple electrical interfaces.

FIG. 11 is a perspective view of another embodiment of the present disclosure having another stabilizer locking member that comprises a pin.

FIGS. 12 and 13 collectively illustrate various embodiments of charging circuitry the can be used in accordance with the present disclosure.

FIG. 14 illustrates the example embodiment of the example device of FIG. 1 in use.

### DETAILED DESCRIPTION

Generally described, the present technology involves devices that are used to charge electronic devices. Example types of electronic devices that can be charged using the present technology include, but are not limited to, cellular telephones, Smartphones, PDAs, tablets, phablets, laptops, or any other mobile electronic device that requires recharging through an electrical interface or charging port, using any of direct current and/or alternating current.

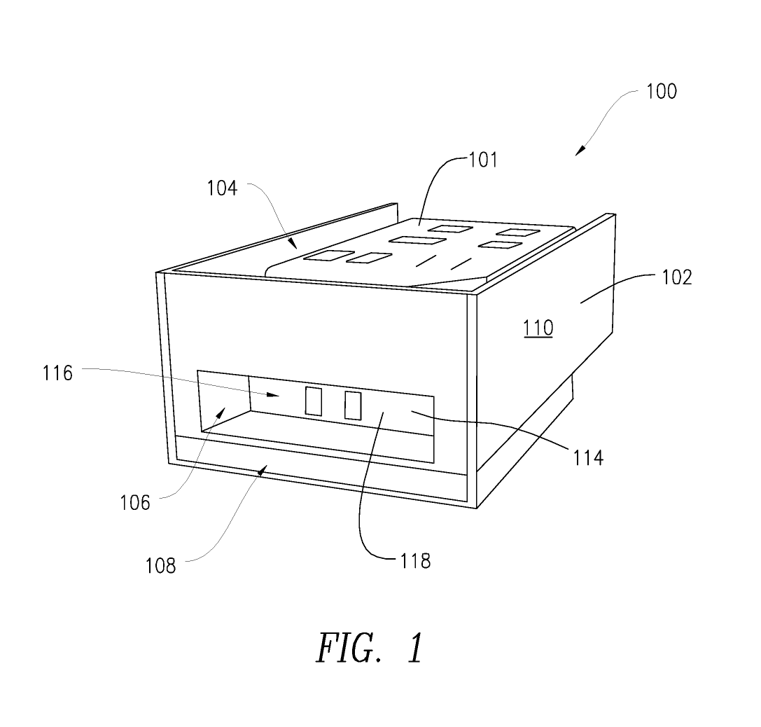

FIGS. 1-3 collectively illustrate an example charging case 100 for a computing device 101. The charging case 100 comprises a body 102 that is configured to receive a computing device 101 such as a Smartphone. In one embodiment, the body 102 comprises a device receiving compartment 104, a middle compartment 106 (also referred to herein as a first compartment), and a lower-most compartment 108 (also referred to herein as a second compartment).

In one embodiment, the device receiving compartment 104 is configured to protectingly surround at least a portion of a computing device 101. In some embodiments, the computing device 101 nests within the device receiving compartment 104 in such a way that a touch screen display or a keyboard of the computing device 101 is exposed, to allow a user to utilize the touch screen display and/or the keyboard.

By way of example, the device receiving compartment 104 cradles the computing device 101 as with a cell phone case that protects a Smartphone. The device receiving compartment 104 can also be configured to receive and retain a computing device such as a laptop. In some embodiments where the charging case 100 receives a laptop; the charging case 100 can function as a part of the chassis of the laptop.

Thus, in another embodiment the device receiving compartment 104 is defined by a sidewall 110 that covers at least a portion of a sidewall of the computing device 101. The back surface or lower surface of the computing device 101 contacts an inner surface 112 of the device receiving compartment 104.

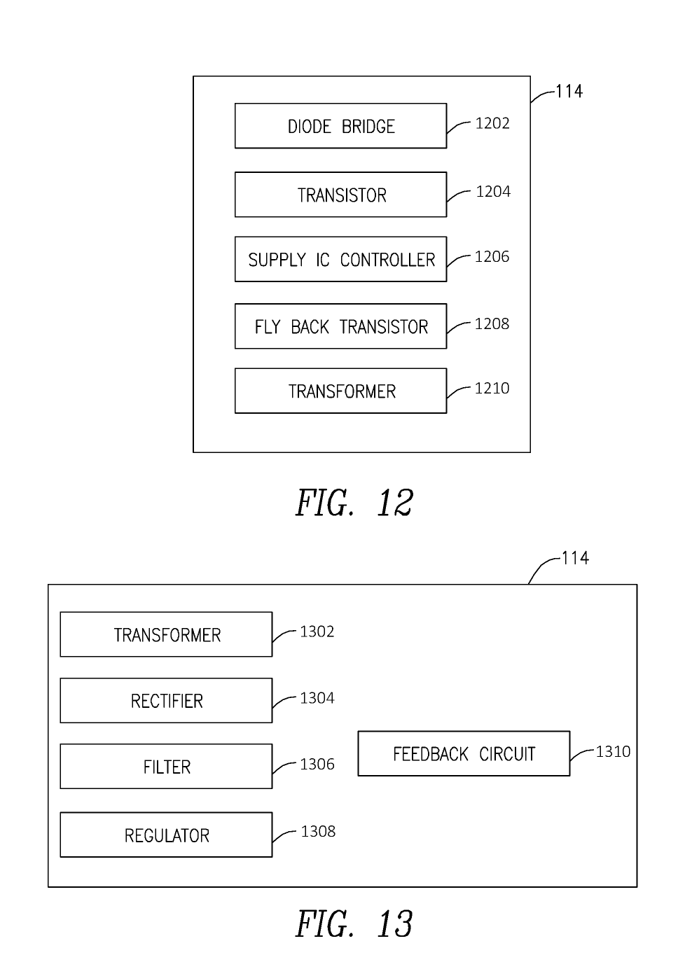

The middle compartment 106 is positioned below or behind the device receiving compartment 104. The middle compartment 106 receives and retains a charging circuit 114. Examples of circuit 114 are further described below and illustrated in FIGS. 12 and 13.

In some embodiments, the circuit 114 can be omitted all together, such as when the DC source provides a DC power signal that does not require amplification or any signal processing.

Rather than plugging into a USB electrical outlet, the electrical connector can be coupled with a USB port of another computing device, such as a laptop computer or a charger device that plugs into a standard two or three pronged electrical wall outlet.

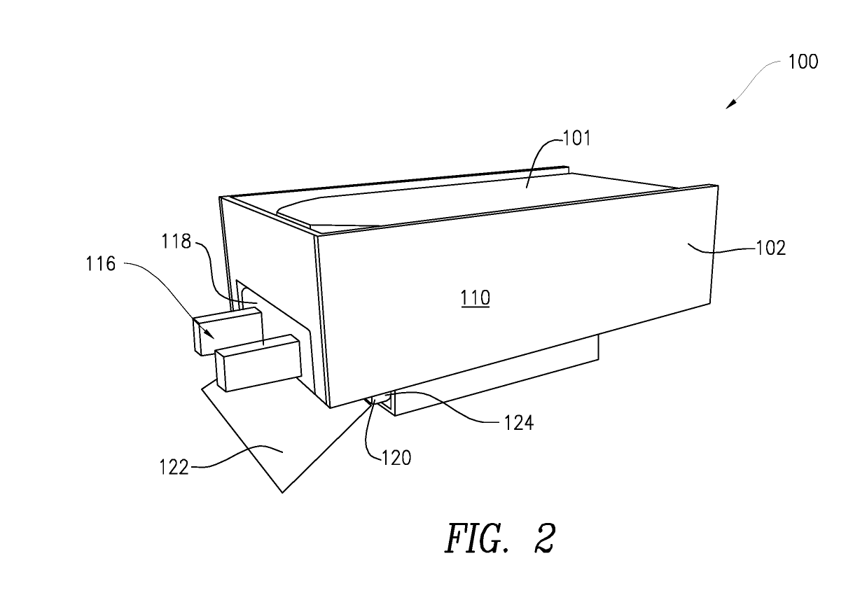

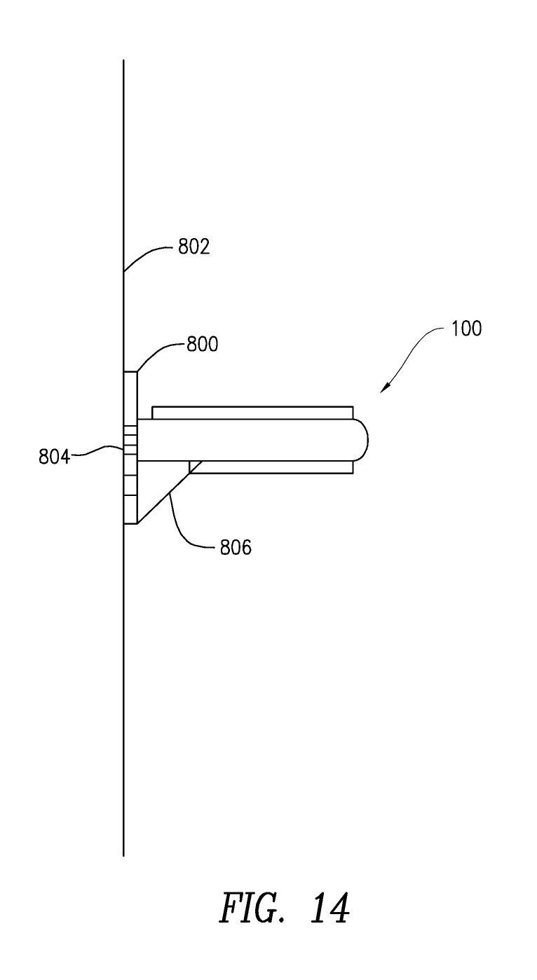

In one embodiment, a circuit 114 is housed within a circuit enclosure 118. The circuit enclosure 118 is disposed within the middle compartment 106. In some embodiments the circuit enclosure 118 can freely translate forwards and backwards within the middle compartment 106. This allows a charging interface 116 to be translated between a deployed configuration (as illustrated in FIG. 2, for example) and a stored configuration (as illustrated in FIG. 1, for example). In FIG. 1, the charging interface 116 comprises a pair of electrical prongs. In various other embodiments, the charging interface 116 may comprise a USB connector, a micro USB connector, or any other connector capable of interfacing with a DC source. The electrical prongs are received within an electrical outlet, as best illustrated in FIG. 14, which illustrates the charging case 100 in use.

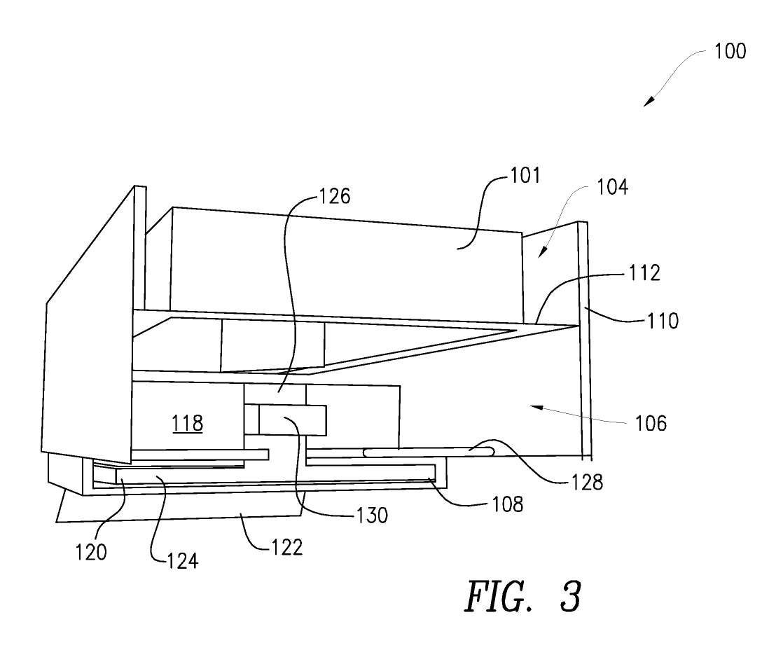

In one embodiment, the lower-most compartment 108 can house a stabilizer 120 that stabilizes the charging case 100 against a wall or other similar surface when the charging interface 116 is deployed. To be sure, the weight of the charging case 100 in combination with the weight of computing device 101 could potentially damage electrical prongs when the electrical prongs are placed in the outlet, by bending of the electrical prongs. The stabilizer 120 (as illustrated in FIGS. 2 and 3, for example) supports at least a portion of the weight that would otherwise be exerted upon the electrical prongs. In another embodiment, the stabilizer 120 includes a flat plate that slides in and out of the lower-most compartment 108. As illustrated in FIG. 2, the stabilizer 120 can comprise a fold-down flap portion 122 that extends at an angle relative to the charging case 100. The fold-down flap portion 122 can be hingedly connected to the first portion 124 of the stabilizer 120 when it remains mostly within the lower-most compartment 108.

In some embodiments, the stabilizer 120 and circuit enclosure 118 can translate independently from one another. For example, the circuit enclosure 118 can be translated forwardly and backwardly as desired to deploy or store the charging interface 116, without requiring the use of the stabilizer 120.

In one embodiment, the stabilizer 120 provides an additional point of contact to support the computing device 101 and charging case 100 against a wall or other similar vertical surface.

FIG. 3 illustrates a coupling of a circuit enclosure 118 with a stabilizer 120. In one embodiment, a connector bar 126 couples a circuit enclosure 118 in the stabilizer 120. To permit for movement of the connector bar 126, a divider 128 that divides the middle compartment 106 from the lower-most compartment 108 is notched. The connector bar 126 (also referred to herein as a linkage) can move forward and backward due to the presence of the notch within the divider 128.

In some embodiments, a finger tab or protrusion 130 is disposed on the connector bar 126. The protrusion 130 allows a user to push or pull the circuit enclosure 118 and stabilizer 120, to deploy or store the charging interface 116 and/or stabilizer 120. For example, pushing the protrusion 130 forwardly causes the circuit enclosure 118 and stabilizer 120 to move forwardly, placing the charging interface 116 and/or stabilizer 120 in a deployed configuration. The user can pinch and pull the protrusion 130 backwardly to cause the charging interface 116 to be stored within the middle compartment 106 and the stabilizer 120 to retract into the lower-most compartment 108.

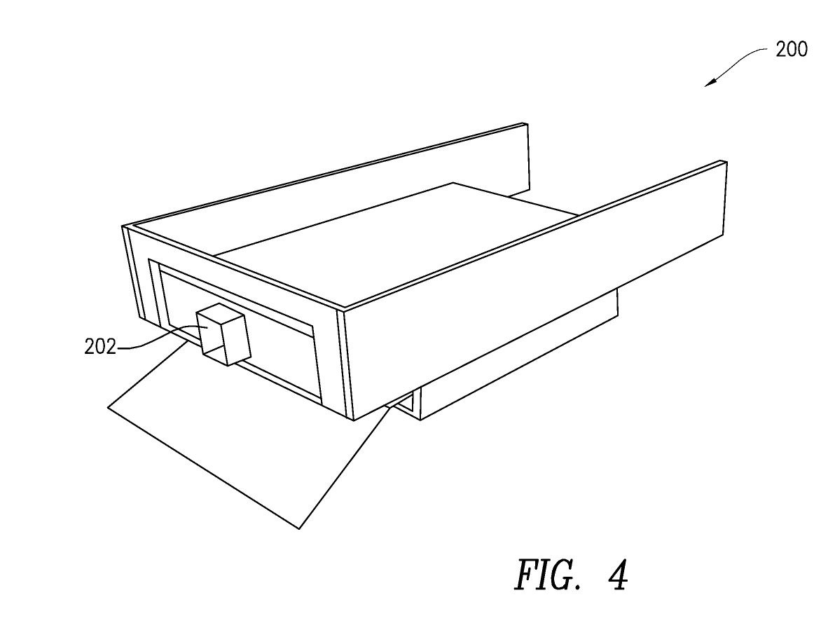

FIG. 4 illustrates another example embodiment of a charging case 200 that is similar in construction to the charging case 100 of FIG. 1, with the exception that the charging case 200 comprises a vertically oriented USB connector 202 in place of the electrical prongs in the charging case 100 of FIG. 1. The USB connector 202 is a charging interface that can couple with a DC power source such as a USB port.

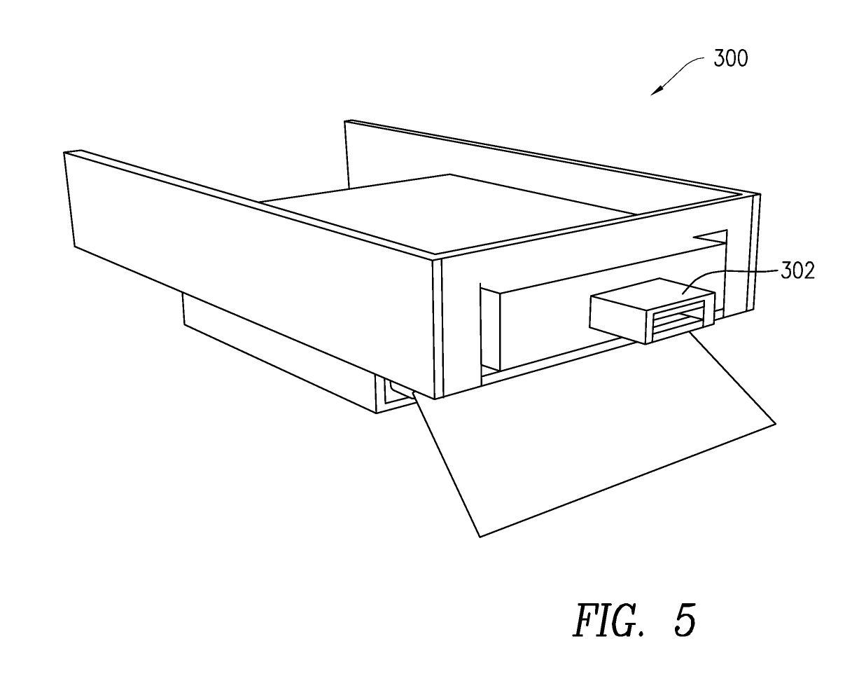

FIG. 5 illustrates another example embodiment of a charging case 300 that is similar in construction to the charging case 100 of FIG. 1, with the exception that the charging case 300 comprises a horizontally oriented USB connector 302 in place of the electrical prongs in the charging case 100 of FIG. 1. Again, the USB connector 302 is a charging interface can couple with a DC power source such as a USB port.

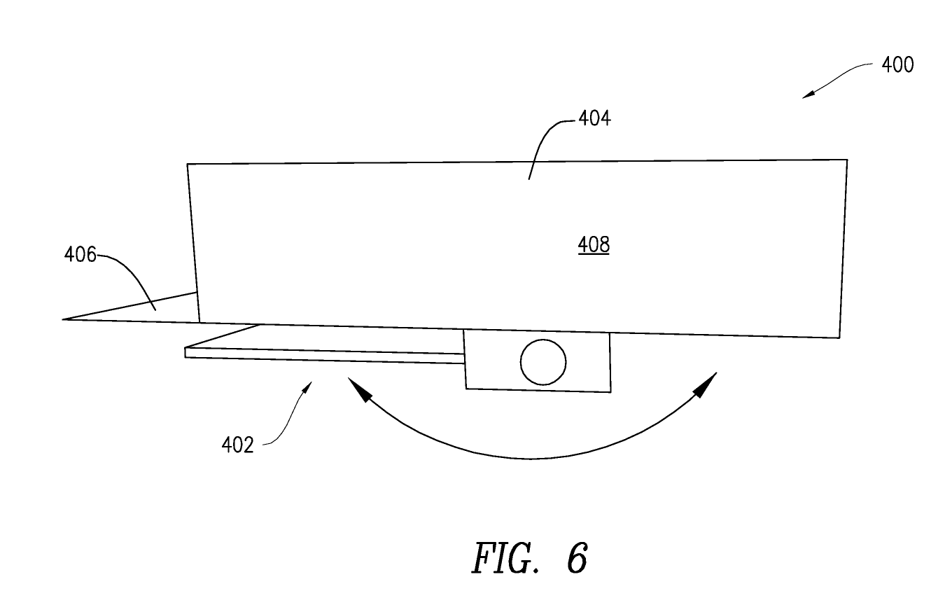

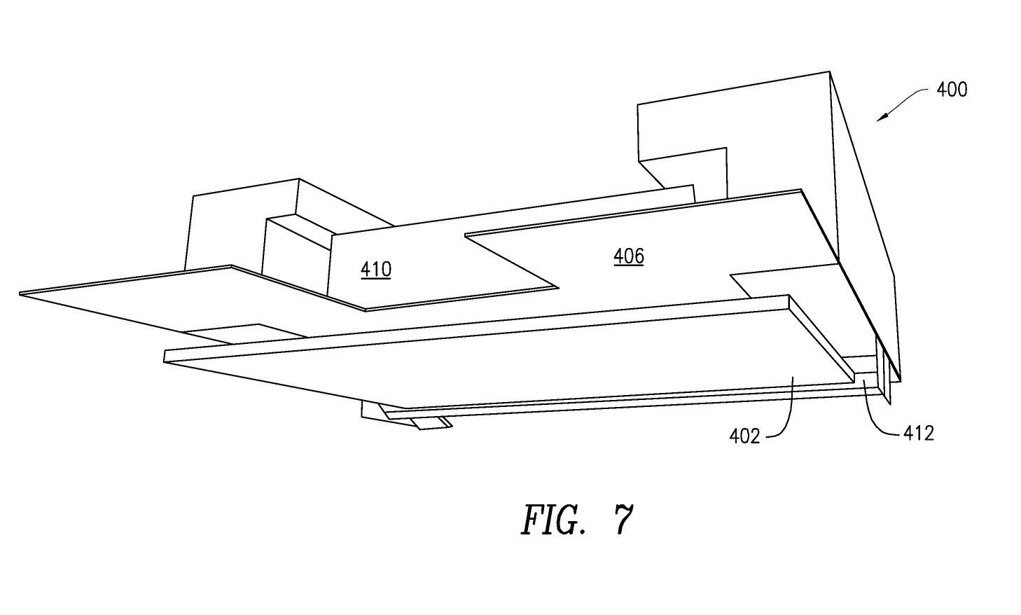

FIG. 6 illustrates another example embodiment of a charging case 400 that is similar in construction to the charging case 100 of FIG. 1, with the exception that a stabilizer 402 is not disposed within a compartment, but is instead, pivotally connected to a lower side of the charging case 400. The charging case 400 comprises a device receiving tray 404, which can receive and retain a computing device. In some embodiments, an inner panel 406 extends beyond a sidewall 408 of the device receiving tray 404. As best illustrated in FIG. 7, the inner panel 406 is notched to allow a finger of the user to press on a charging enclosure 410 to deploy a charging interface of the charging case 400 such as electrical prongs or a USB connector. The stabilizer 402 is illustrated in a stored configuration in FIGS. 6 and 7.

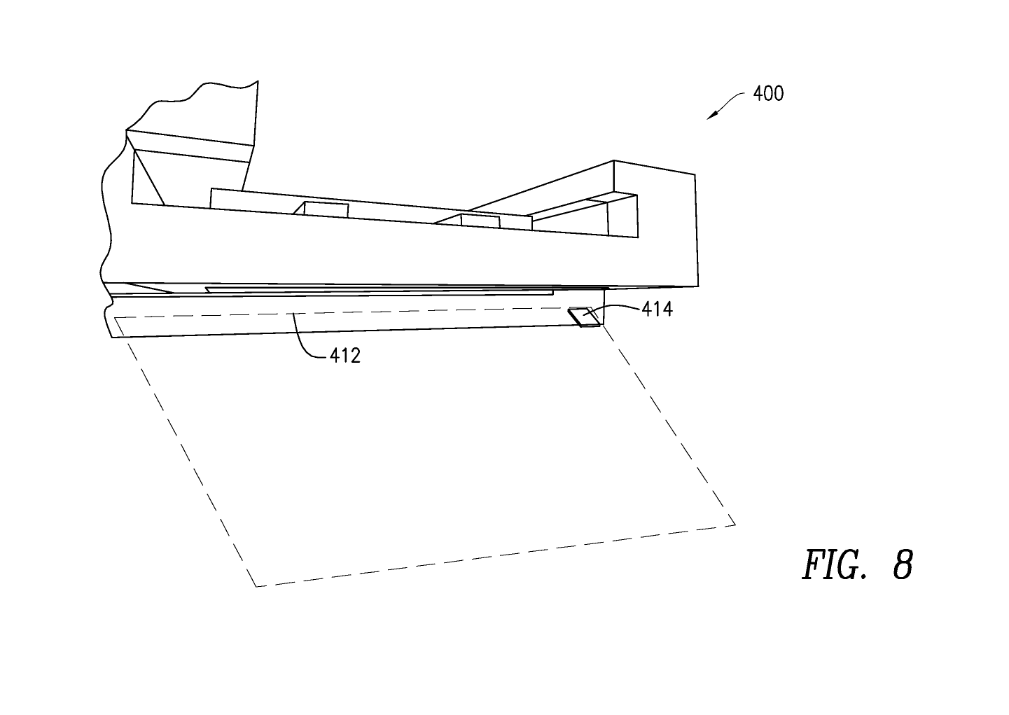

FIG. 8 illustrates a stabilizer bar 412 that comprises a locking member or support 414. The stabilizer 402 can rotate about the stabilizer bar 412 and can also slide laterally along the stabilizer bar 412, such that the stabilizer 402 can clear the edge of the locking member or support 414. Once the stabilizer 402 is rotated above the locking member or support 414, the stabilizer 402 can slide over the top of the locking member of support 414. This stabilizer 402 can then rest on top of the locking or support member 414, so as to secure the stabilizer 402 in an angled orientation that corresponds to an angle of the locking member or support 414. For reference, the stabilizer 402 can be coupled with the stabilizer bar 412, as illustrated in the additional embodiment FIG. 7.

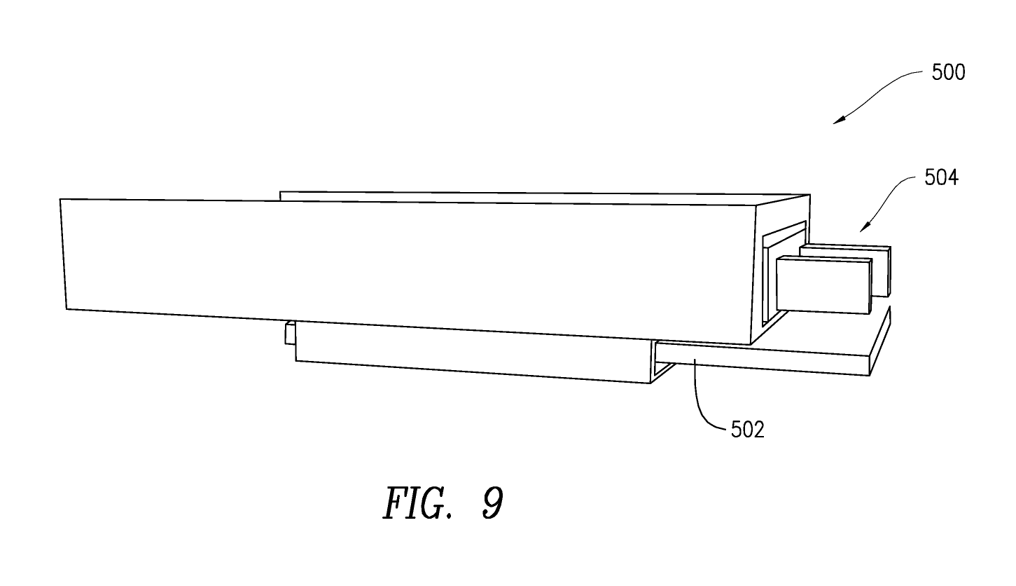

FIG. 9 illustrates another example embodiment of a charging case 500 that is similar in construction to the charging case 100 of FIG. 1. In this particular embodiment, a stabilizer 502, when extended from its compartment, will extend to a length that is equal in length to a charging interface 504. That is, when the charging interface 504 is deployed along with the stabilizer 502, their terminal ends are co-planar or in alignment with one another.

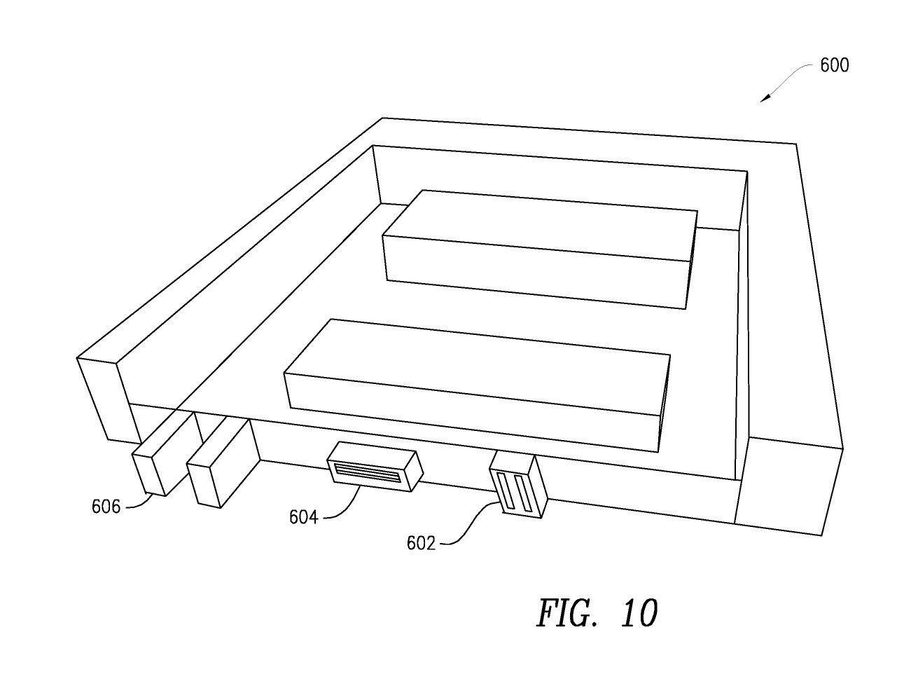

FIG. 10 illustrates another example embodiment of a charging case 600 that is similar in construction to the charging case 100 of FIG. 1, with the exception that the charging case 600 comprises a plurality of charging interfaces. For example, the charging case 600 can comprise various combinations of a vertically oriented USB connector 602, a horizontally oriented USB connector 604, and electrical prongs 606. Thus, the charging case 600 may be capable of connecting to both DC and AC power sources. Indeed, the charging case 600 can comprise two or more different and unique charging interfaces of any selection in various orientations.

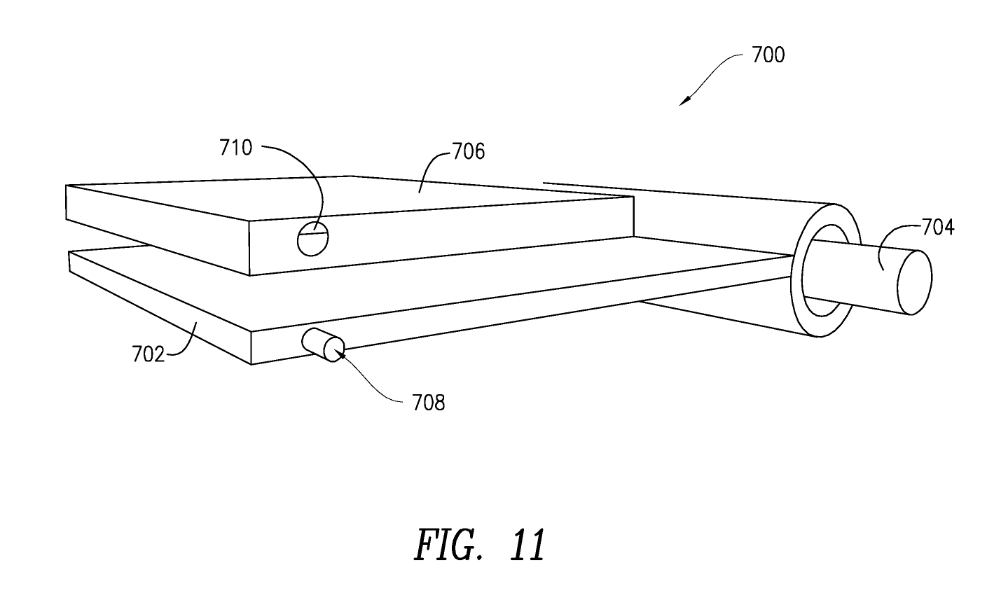

FIG. 11 illustrates another example embodiment of another stabilizer 700 that can be used in any of the embodiments described above in place of having a charging case's respective stabilizer as previously described. In some embodiments, the stabilizer 700 comprises a stabilizer plate 702. The stabilizer plate 702 can be rotatingly coupled to a stabilizer bar 704 that can be joined to a charging case housing 706. In some embodiments, the stabilizer plate 702 comprises a peg 708 that is configured to couple within aperture 710 that is formed into an edge of the charging case housing 706. The stabilizer plate 702 can slide laterally along the stabilizer bar 704.

FIGS. 12 and 13 collectively illustrate various embodiments of charging circuitry the can be used in accordance with the present disclosure. As illustrated in FIG. 12, according to some embodiments, circuit 114 can comprise a printed circuit board with various permutations of electrical components. In general, the circuit 114 is configured to transform the AC power waveform received from an outlet into DC power that is appropriate for charging the computing device 101.

In some embodiments, the circuit 114 can include combinations of electrolytic capacitors, MOSFET switching transistors, flyback transformers, a controller integrated circuit, capacitors, diodes, R-C snubber circuits, EMI (electromagnetic interference) circuits, inductors, control chips, Schottky diodes, Tantalum filter capacitors, as well as any combinations thereof, in order to provide the desired transformation of AC to DC functions.

In some embodiments, the circuit 114 is an advanced flyback switching power supply that receives the AC voltage in ranges of 100 to 240 volts, and produces approximately five watts of smooth voltage power. AC line power is converted to high voltage DC current using a diode bridge 1202. The DC power is switched off and on by a transistor 1204 controlled by a power supply IC controller 1206. The circuit 114 may comprise a fly back (flyback) transistor 1208. The circuit 114 can also comprise a transformer 1210 that converts the DC power to a low voltage AC waveform.

In other embodiments, such as in FIG. 13 a chopped DC power supply is fed back into the transformer 1210 (which can include a fly back transformer), which converts the DC power to a low voltage AC waveform. The AC waveform is then converted into DC using a rectifier and then filtered with a filter to obtain smooth power that is substantially free of interference. This smoothed power is provided to a USB port (e.g., charging interface 116).

While the use of a USB port is contemplated, the charging interface 116 can be selectively changed depending upon the type of electrical device that needs to be charged. Other examples include power over Ethernet, firewire, MIDI, Thunderbolt, and so forth.

In another example circuit, illustrated in FIG. 13, the circuit 114 comprises a transformer 1302 that performs a step down of the AC voltage received from an outlet to a working output voltage. A rectifier 1304 then converts the stepped down voltage from AC to DC. In some embodiments, the rectifier 1304 is a full wave bridge rectifier. A filter 1306, such as a capacitor, may be used to smooth the DC voltage. A regulator 1308 can also be employed to even further smooth the DC current. For example, a zener diode or IC voltage regulator can be utilized. The circuit 114 can comprise a feedback circuit 1310 that measures the voltage output to the charging interface 116 and sends a signal to the power supply IC controller (such as the one illustrated in FIG. 12, which adjusts the switching frequency to obtain a desired voltage).

The circuits of FIGS. 12 and 13 are merely example circuits that can be used to transform the AC power received at a wall outlet to a DC power feed that can be used to charge an electronic device without causing any damage to the circuitry of the electronic device. In some embodiments, components from the circuits of FIGS. 12 and 13 can be combined into a single circuit.

To be sure, the circuit 114 can also be configured to amplify or reduce DC power received from an electrical outlet. In one embodiment, the electrical outlet includes a USB port that is configured to deliver DC power. Some embodiments of USB connectors, and specifically wall outlet based USB connectors may carry AC power. Thus, the circuit 114 can be configured with any of the components of FIGS. 12 and 13 above to deliver the correct type of power.

FIG. 14 illustrates an example embodiment of the charging case 100 of FIG. 1 in use. For example, the charging case 100 can be coupled with an electrical outlet 800 of a wall 802. The wall 802 is a vertically oriented surface that supports the charging case 100. When the charging interface 804, such as electrical prongs, is inserted into the electrical outlet 800, a stabilizer 806, when in the deployed configuration, contacts a portion of the wall 802 below the electrical outlet 800 or the electrical outlet 800 itself. Again, the stabilizer 806 supports at least a portion of the weight of the charging case 100 and the computing device disposed therein.

The present disclosure has been described more fully with reference to the accompanying drawings, in which example embodiments of the present disclosure are shown. The present disclosure may, however, be embodied in many different forms and should not be construed as necessarily being limited to the example embodiments set forth herein. Rather, these example embodiments are provided so that the disclosure is thorough and complete, and fully conveys the concepts of the present disclosure to those skilled in the art. Also, features described with respect to certain example embodiments may be combined in and/or with various other example embodiments. Different aspects and/or elements of example embodiments, as disclosed herein, may be combined in a similar manner. Further, at least some example embodiments may individually and/or collectively be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, can be at least partially performed via at least one entity, at least as described herein, in any manner, irrespective of the at least one entity have any relationship to the subject matter of the present disclosure.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

Although the terms first, second, etc. may be used herein to describe various elements, components, regions, layers and/or sections, these elements, components, regions, layers and/or sections should not necessarily be limited by such terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

The terminology used herein is for the purpose of describing particular embodiments only and is not intended to be necessarily limiting of the disclosure. As used herein, the singular forms “a,” an and the are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing and/or other any other types of manufacturing. For example, some manufacturing processes include three dimensional (3D) printing, laser cutting, computer numerical control (CNC) routing, milling, pressing, stamping, vacuum forming, hydroforming, injection molding, lithography and/or others.

Any and/or all elements, as disclosed herein, can include, whether partially and/or fully, a solid, including a metal, a mineral, a ceramic, an amorphous solid, such as glass, a glass ceramic, an organic solid, such as wood and/or a polymer, such as rubber, a composite material, a semiconductor, a nano-material, a biomaterial and/or any combinations thereof. Any and/or all elements, as disclosed herein, can include, whether partially and/or fully, a coating, including an informational coating, such as ink, an adhesive coating, a melt-adhesive coating, such as vacuum seal and/or heat seal, a release coating, such as tape liner, a low surface energy coating, an optical coating, such as for tint, color, hue, saturation, tone, shade, transparency, translucency, non-transparency, luminescence, anti-reflection and/or holographic, a photo-sensitive coating, an electronic and/or thermal property coating, such as for passivity, insulation, resistance or conduction, a magnetic coating, a water-resistant and/or waterproof coating, a scent coating and/or any combinations thereof.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

Furthermore, relative terms such as “below,” “lower,” “above,” and “upper” may be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings is turned over, then the elements described as being on the “lower” side of other elements would then be oriented on “upper” sides of the other elements. Similarly, if the device in one of the figures is turned over, elements described as “below” or “beneath” other elements would then be oriented “above” the other elements. Therefore, the example terms “below” and “lower” can, therefore, encompass both an orientation of above and below.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A device, comprising:
a charging case that protectingly surrounds or encases a computing device in such a way that a touchscreen display or keyboard is at least partially exposed to allow a user to utilize the touchscreen display or keyboard;
a charging circuit disposed within the charging case; and
a charging interface extending from the charging case.

2. The device according to claim 1, further comprising a stabilizer that is configured to support both the charging case and the computing device against a vertical surface when the charging interface is plugged into a charging port.

3. The device according to claim 2, wherein the stabilizer slidingly translates between a deployed position and a stored position.

4. The device according to claim 3, wherein the stabilizer and the charging interface are coupled is such a way that translation of the stabilizer causes a corresponding translation of the charging interface.

5. The device according to claim 2, wherein the stabilizer is disposed within a rearward compartment on a rearmost side of the charging case.

6. The device according to claim 5, wherein the stabilizer comprises a folding portion that pivots downwardly after the stabilizer is slid at least partially from the rearward compartment.

7. The device according to claim 2, wherein the stabilizer hingedly translates between a deployed position and a stored position.

8. The device according to claim 1, wherein the charging interface comprises any of electrical prongs and a Universal Serial Bus (USB) connector.

9. The device according to claim 1, wherein the charging interface slidingly translates between a deployed position and a stored position.

10. The device according to claim 1, wherein the charging circuit and a battery coupled with the charging circuit are disposed within a middle compartment of the charging case.

11. The device according to claim 10, wherein a divider that joins the middle compartment and a rearward compartment that comprises a stabilizer is notched to allow for a finger of the user when the finger is used to translate the charging interface and the stabilizer.

12. The device according to claim 11, wherein the stabilizer and the middle compartment are joined together by a linkage tab that can be pushed or pulled by the user.

13. A case for a computing device, comprising:
a charging case that protectingly surrounds a computing device in such a way that a touchscreen display or keyboard is at least partially exposed to allow a user to utilize the touchscreen display or keyboard;
a charging circuit disposed within a middle compartment of the charging case, the middle compartment being disposed behind or below the computing device;
a charging interface selectively extendable from the charging case; and
an extendable stabilizer disposed within a rearward compartment behind the middle compartment, the extendable stabilizer translatable between a stored configuration and a deployed configuration.

14. The case according to claim 13, wherein the extendable stabilizer supports both the charging case and the computing device against a vertical surface when the charging interface is plugged into a charging port.

15. The case according to claim 13, wherein the charging interface comprises any of electrical prongs and a Universal Serial Bus (USB) connector.

16. The case according to claim 13, wherein the charging interface slidingly translates between a deployed position and a stored position.

17. A case for a smartphone, comprising:
a charging case that protectingly surrounds a smartphone;
a first compartment coupled to a rearward portion of the charging case;
a charging circuit disposed within the first compartment;
a charging interface extendable from the charging case, the charging interface disposed within the first compartment;
a second compartment coupled to a rearward portion of the first compartment; and
a stabilizer that is extendable from the second compartment.

18. The case according to claim 17, wherein the stabilizer slidingly translates between a deployed position and a stored position, and the stabilizer and the charging interface are coupled together is such a way that translation of the stabilizer causes a corresponding translation of the charging interface.

19. The case according to claim 18, further comprising a finger tab that extends from a connector bar that joins the stabilizer and the charging interface.

20. The case according to claim 17, further comprising additional charging interfaces, wherein the charging interface comprises electrical prongs and the additional charging interfaces comprise a vertically oriented USB interface and a horizontally oriented USB interface.
